(19) United States
(12) Patent Application Publication
(10) Pub. No.: US 2025/0388452 A1
(43) Pub. Date: Dec. 25, 2025

(54) Air Pressure Liquid Transfer System

(71) Applicant: Norman Ted Walton, Port Alberni (CA)

(72) Inventor: Norman Ted Walton, Port Alberni (CA)

(21) Appl. No.: 19/233,691

(22) Filed: Jun. 10, 2025

Related U.S. Application Data
(60) Provisional application No. 63/661,674, filed on Jun. 19, 2024.

(51) Int. Cl. B67D 7/04; B67D 7/36; B67D 7/58

(52) U.S. Cl. CPC B67D 7/04; B67D 7/36; B67D 7/58

(57) ABSTRACT

An air pressure liquid transfer system is provided. The device is system is configured to transfer liquid from a heavy or stationary container to a target receptacle through the use of pressurization. The system comprises a liquid transfer assembly that utilizes air pressure generated by at least one pump to displace liquid from the container. This pressure forces the liquid through a flexible hose connected to a nozzle, which includes fasteners for secure attachment to receiving inlets. The hose may feature quick-connect fasteners and retractable mechanisms for ease of use. Structural supports, including external frames, handles, and wheels, provide stability and mobility. The system may also be adapted to interface with existing containers through a modular lid and side supports.

### CROSS-REFERENCE TO RELATED APPLICATION

The present application claims priority to, and the benefit of, U.S. Provisional Application No. 63/661,674, which was filed on Jun. 19, 2024, and is incorporated herein by reference in its entirety.

### FIELD OF THE INVENTION

The present invention relates generally to the field of fuel containers. More specifically, the present invention relates to a system configured to transfer liquid from a heavy or stationary container to a target receptacle through the use of pressurization. Accordingly, the present disclosure makes specific reference thereto. Nonetheless, it is to be appreciated that aspects of the present invention are also equally applicable to other like applications, devices, and methods of manufacture.

### BACKGROUND

In various industrial, commercial, and domestic environments, the transfer of liquids from large or heavy containers often results in significant inefficiencies and operational challenges. Traditional methods, which typically require manual lifting or tilting of containers, can lead to frequent spillage, posing both safety hazards and material loss. Additionally, lids removed during the liquid transfer process are frequently misplaced, contributing to contamination risks and operational delays. Containers occupying valuable workspace further exacerbate the issue, as they limit the functional area available for other critical tasks. These problems are particularly prevalent in environments where liquids such as fuel, chemicals, or water are stored in heavy or stationary containers that are impractical to move manually. Manual handling of such containers increases the risk of workplace injuries and complicates compliance with safety regulations. Furthermore, conventional transfer methods often lack the precision and control necessary to ensure accurate and efficient liquid dispensing. The need for a reliable, controlled, and space-efficient method for transferring liquids from immovable or heavy containers has therefore become a pressing concern in various industries.

Therefore, there exists a long-felt need in the art for an air pressure liquid transfer system that enables efficient liquid transfer from heavy or stationary containers without manual lifting. There also exists a long-felt need in the art for an air pressure liquid transfer system that prevents liquid spillage and secures all components during use. Moreover, there exists a long-felt need in the art for an air pressure liquid transfer system that minimizes workspace occupation while maintaining operational efficiency.

The subject matter disclosed and claimed herein, in one embodiment thereof, comprises an air pressure liquid transfer system. The device is system is configured to transfer liquid from a heavy or stationary container to a target receptacle through the use of pressurization. The system comprises a liquid transfer assembly that utilizes air pressure generated by at least one pump to displace liquid from the container. The container may be constructed of corrosion-resistant plastic with a double-walled structure incorporating an impact-resistant membrane. The interior space of the container is configured to store various liquids, while the pump, which may be manual, foot-actuated, or electrically powered, introduces compressed air into the container to generate pressure. This pressure forces the liquid through a flexible hose connected to a nozzle, which includes fasteners for secure attachment to receiving inlets. The hose may feature quick-connect fasteners and retractable mechanisms for ease of use. Structural supports, including external frames, handles, and wheels, provide stability and mobility. The system may also be adapted to interface with existing containers through a modular lid and side supports. Various valves regulate airflow and prevent backflow, and additional components such as pressure gauges and air release valves ensure controlled operation.

In this manner, the air pressure liquid transfer system of the present invention accomplishes all the forgoing objectives and provides an efficient and safe system for the transferring of liquids from heavy containers without the need for manual handling, thereby reducing the risk of spills and lost components. The system secures the nozzle and hose during both use and storage, ensuring operational integrity and minimizing contamination risks. Additionally, through the use of structural supports, modular adaptability, and compact design, the air pressure liquid transfer system reduces workspace occupation, allowing for more effective utilization of work areas while maintaining high performance in liquid transfer operations.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an air pressure liquid transfer system. The system is comprised of a system configured to transfer liquid from heavy or stationary containers to a target receptacle using air pressure generated by at least one pump. The system is suited for use with containers that are impractical to lift or tilt, such as large fuel cans, chemical storage tanks, or industrial barrels.

The system includes a container configured to store liquid. The container may be of any shape or size and is preferably manufactured from corrosion-resistant and spark-inhibiting plastic. One embodiment includes a double-walled structure comprising a membrane positioned between an outer and inner wall to provide impact resistance and thermal insulation.

The container is connected to at least one pump configured to introduce compressed air into the interior space, thereby generating pressure that displaces the liquid through a force main and nozzle. The pump may be molded onto the exterior surface of the container and may include a manual hand-actuated pump, a flip-out foot pump, an electric pump, or a solar-powered pump. One variation includes an expandable bladder attached to the pump to increase internal pressure.

A nozzle is connected to the container through a flexible, pressure-resistant hose. The nozzle may be of various types and includes at least one fastener for secure attachment to receiving inlets. The hose is attached via quick-connect fasteners for tool-free operation. When not in use, the nozzle and hose are secured using molded fasteners and optional spring-loaded retraction mechanisms. One embodiment includes a retractable mechanism attached to the container that maintains fluid communication between the hose and the force main via an additional connection hose and outlet.

To prevent deformation under pressure, the container may include at least one external frame support connected via mechanical fasteners. The support may also include a handle and wheels to facilitate transport across work areas. The container may also be equipped with an external lifting handle secured via embedded or integrated anchoring structures. Additional features may include a pressure gauge for monitoring and an air release valve for manual or automatic depressurization.

In an alternative modular embodiment, the system is configured to interface with existing containers via a lid that integrates the pump and seals the container. The hose attaches to the lid using quick-connect fasteners. The lid also includes an air outlet for pressure release and integrates at least one one-way valve in the pump to control air flow direction. In this embodiment, a handle-actuated piston mechanism introduces air into the container through a valve sequence that prevents liquid backflow and air bubble formation. The valves may be of any suitable type, including ball and spring or flap configurations.

The force main may include a telescopic configuration for adjustable length based on fill level or container height, and the pump may be integrated within the force main. Additional side supports may be attached to existing containers using adjustable fasteners to prevent deformation during pressurization.

In a further embodiment, the system is adapted for water jugs using a flexible base secured around the jug neck with a fastener to ensure an airtight seal and maintain pressurization.

Accordingly, the air pressure liquid transfer system of the present invention is particularly advantageous as it provides an efficient and safe system for the transferring of liquids from heavy containers without the need for manual handling, thereby reducing the risk of spills and lost components. The system secures the nozzle and hose during both use and storage, ensuring operational integrity and minimizing contamination risks. Additionally, through the use of structural supports, modular adaptability, and compact design, the air pressure liquid transfer system reduces workspace occupation, allowing for more effective utilization of work areas while maintaining high performance in liquid transfer operations. In this manner, the air pressure liquid transfer system overcomes the limitations of existing liquid transfer devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of an air pressure liquid transfer system of the present invention in accordance with the disclosed architecture;

FIG. 2 illustrates a side view of one potential embodiment of an air pressure liquid transfer system of the present invention in accordance with the disclosed architecture;

FIG. 3 illustrates a side view of one potential embodiment of an air pressure liquid transfer system of the present invention in accordance with the disclosed architecture;

FIG. 4 illustrates a side cross-sectional view of a container body of one potential embodiment of an air pressure liquid transfer system of the present invention in accordance with the disclosed architecture;

FIG. 5 illustrates a side cross-sectional view of one potential embodiment of an air pressure liquid transfer system of the present invention in accordance with the disclosed architecture;

FIG. 6 illustrates a perspective view of one potential embodiment of an air pressure liquid transfer system of the present invention when applied to an existing gas can in accordance with the disclosed architecture;

FIG. 7 illustrates a side cross-sectional view of one potential embodiment of an air pressure liquid transfer system of the present invention when applied to an existing water jug in accordance with the disclosed architecture;

FIG. 8 illustrates a front view of one potential embodiment of an air pressure liquid transfer system of the present invention in accordance with the disclosed architecture;

FIG. 9 illustrates a side view of one potential embodiment of an air pressure liquid transfer system of the present invention in accordance with the disclosed architecture;

FIG. 10 illustrates a side cross-sectional view of one potential embodiment of an air pressure liquid transfer system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an air pressure liquid transfer system that enables efficient liquid transfer from heavy or stationary containers without manual lifting. There also exists a long-felt need in the art for an air pressure liquid transfer system that prevents liquid spillage and secures all components during use. Moreover, there exists a long-felt need in the art for an air pressure liquid transfer system that minimizes workspace occupation while maintaining operational efficiency.

The present invention, in one exemplary embodiment, is comprised of an air pressure liquid transfer system configured to move liquid from heavy or stationary containers to a target receptacle by means of air pressure generated by at least one pump. This configuration is especially useful for containers that cannot be easily lifted or tilted, such as large fuel cans, chemical storage tanks, or industrial barrels.

The system features a container designed to store liquid, which may be any shape or size. The container is preferably fabricated from a corrosion-resistant, spark-inhibiting plastic. One embodiment incorporates a double-walled construction, wherein a membrane is located between the outer and inner walls to enhance thermal insulation and impact resistance.

Compressed air is introduced into the container's interior via at least one connected pump, which increases internal pressure to drive the liquid through a force main and out through a nozzle. The pump may be formed directly on the exterior surface of the container and can take several forms, including a hand-operated pump, a flip-out foot pump, or an electrically or solar-powered pump. In some configurations, the pump is supplemented by an expandable bladder to elevate internal pressure.

The container connects to a nozzle through a flexible, pressure-resistant hose. The nozzle may be of various designs and includes at least one fastener to ensure secure coupling with a receiving inlet. The hose uses quick-connect fasteners to allow attachment and detachment without tools. Storage of the nozzle and hose is facilitated by molded fasteners or spring-loaded retraction mechanisms. One version employs a retractable mechanism fixed to the container, which preserves fluid continuity between the hose and the force main via an intermediary connection hose and outlet.

To enhance structural stability under pressure, the container may include one or more external frame supports attached using mechanical fasteners. The supports can also incorporate a handle and wheels to aid movement around work environments. The container may additionally feature an external lifting handle affixed using embedded or integrated anchoring structures. Further components may include a pressure gauge for internal monitoring and an air release valve for pressure regulation, either manually or automatically controlled.

An alternative modular configuration enables the system to interface with pre-existing containers by means of a lid that both seals the container and houses the pump. The hose connects to this lid via quick-connect fasteners. The lid also includes an air outlet to relieve pressure and integrates at least one one-way valve into the pump to ensure unidirectional airflow. This version utilizes a piston mechanism, which when actuated by a handle, pushes air through a valve sequence designed to prevent liquid backflow and air bubble accumulation. The valves may be of any suitable type, including ball-and-spring or flap structures.

The force main in certain embodiments may further be telescopic, allowing adjustment in response to liquid level or container height. The pump may also be integrated into the force main. Additional side supports may be attached to existing containers via adjustable fasteners to mitigate bulging during pressurization.

Another embodiment of the system allows the system to be used with water jugs. This variant includes a flexible base that fits around the neck of a water jug and is secured with a fastener to ensure an airtight seal and consistent pressure.

As a result, the air pressure liquid transfer system offers a safe and efficient solution for moving liquids from heavy containers without manual lifting. The system further enhances operational integrity through secure hose and nozzle storage, minimizes contamination risks, and reduces workspace usage by incorporating compact, modular components and structural supports. These improvements collectively address limitations found in conventional liquid transfer methods.

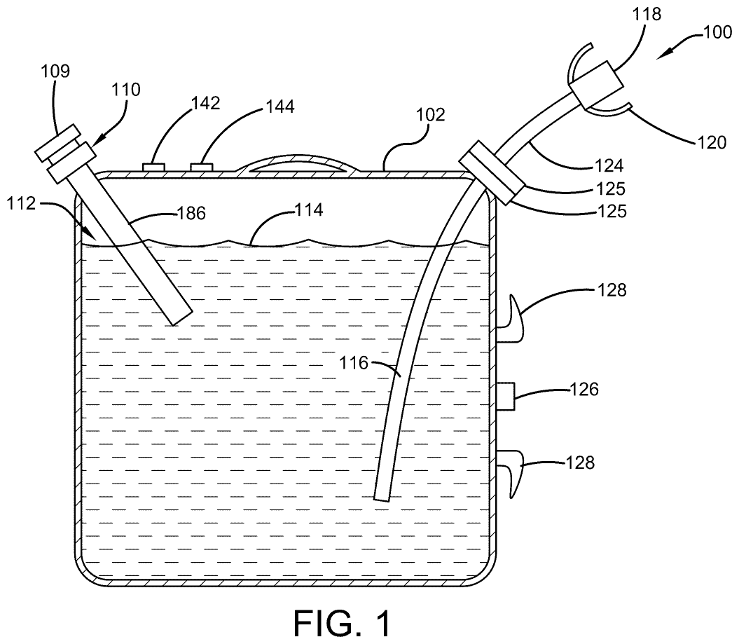

Referring initially to the drawings, FIG. 1 illustrates a side view of one potential embodiment of an air pressure liquid transfer system 100 of the present invention in accordance with the disclosed architecture. The present invention is comprised of a system 100 that allows liquid to be transferred from a container, tank, barrel, etc., that is too heavy to lift and pour via pressurization. More specifically, the system 100 is comprised of a liquid transfer assembly configured to move a liquid 114 from a container 102 to a target receptacle using air pressure generated by at least one pump 110. The system 100 is particularly suited for use with heavy or stationary containers that are impractical to lift or tilt, such as large fuel cans, chemical storage tanks, or industrial barrels.

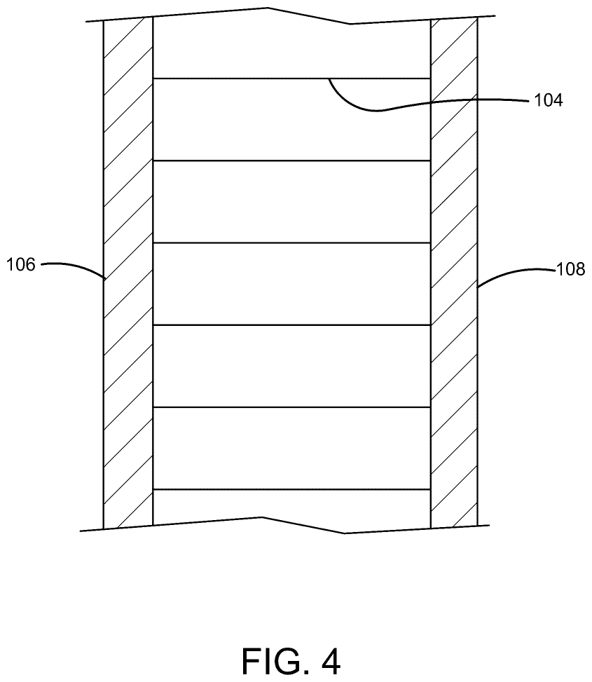

The container 102 may be any type, size, or shape of gas can or fuel container, including conventional rectangular, cylindrical, or custom-molded geometries. The container 102 is preferably manufactured from a corrosion-resistant and spark-inhibiting plastic material, making it suitable for fuel, water, or chemical transport. In one embodiment, the container 102 is further comprised of a double-walled structure, wherein a membrane 104 is positioned between an outer wall 106 and an inner wall 108, as seen in FIG. 4. The membrane 104 may be a honeycomb-structured barrier or other energy-absorbing configuration, intended to provide impact resistance and thermal insulation.

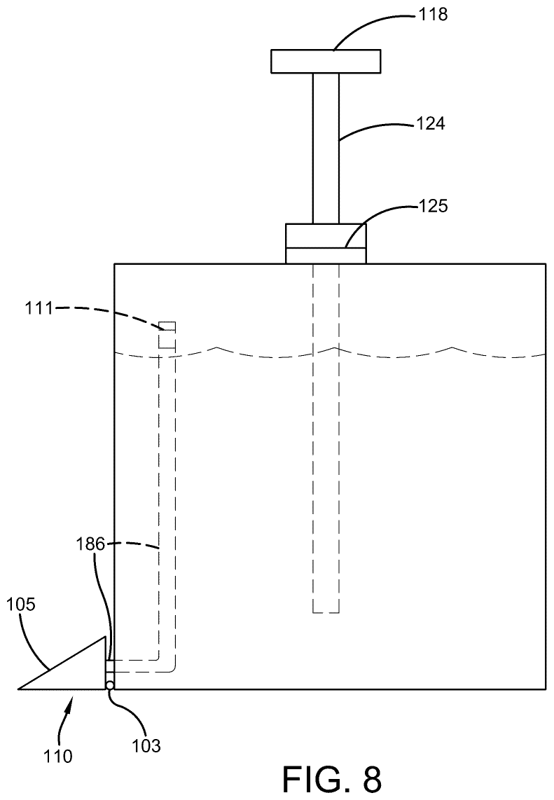

The interior space 112 of the container 102 is configured to store a liquid 114, such as but not limited to a fuel, a chemical, a water, etc. At least one pump 110 is fluidly connected to the interior space 112 of the container 102, allowing a user to introduce compressed air into the container 102 via using the pump 110. In one embodiment, the pump 110 is molded within/on an exterior surface of the container 102. Upon actuation of the pump 110, air pressure builds within the interior space 112, generating force that displaces the liquid 114 upward through a flexible force main 116 and out of the container 102 through a nozzle 118, as seen in FIG. 1. In one embodiment, the pump 110 may be comprised of a hand-actuated pump for portable manual use. In another embodiment, the pump 110 is can be actuated by a foldable or flip-out foot pump 105 (as seen in FIG. 8) attached to the exterior of the container 102 via at least one hinge 103. This allows for more efficient pressurization using body weight. In yet another embodiment, the pump 110 is comprised of an electric or solar-powered pump. In one embodiment, the pump 110 is comprised of an attached expandable bladder 113 that is filled with the air from the pump 110 to increase the pressure within the container 102.

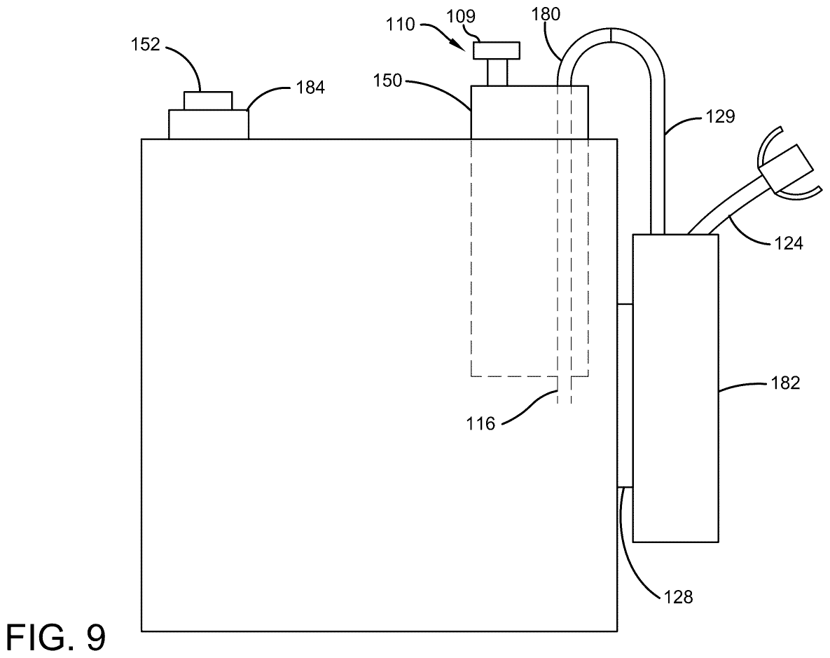

The nozzle 118 may be any type of dispensing head suitable for the liquid being transferred. By way of example, the nozzle 118 may be a fuel nozzles, a flexible spout, or precision a nozzle for controlled flow. The nozzle 118 is further comprised of at least one fastener 120, such as a clip, clamp, or threaded collar, which enables secure attachment to a receiving inlet or filling port. The nozzle 118 is connected to the container 102 via a flexible hose 124. The hose 124 is preferably resistant to deformation under pressure and compatible with the chemical properties of the liquid 114. The hose 124 is attached to the container 102 using a pair of quick-connect fasteners 125 (as seen in FIG. 1), which allow for secure attachment and detachment without tools. When not in use, the nozzle 118 can be stored on at least one fastener 126 mounted on the container 102, as seen in FIG. 1. The fastener 126 may be a molded bracket, hook, or clip that retains the nozzle 118. Additionally, the hose 124 may be secured using a secondary fastener 128, such as a hook, strap, or similar retention element positioned along the container 102 (as seen in FIG. 1). In one embodiment, the secondary fastener 128 receives a spring-loaded coil mechanism 182 (as seen in FIG. 9) that allows the hose 124 to retract within the mechanism 182 when not in use, wherein the hose 124 may be fixedly attached to the mechanism 182. In this embodiment, the mechanism 182 is comprised of an additional connection hose 129 which connects the hose 124 to the quick-connect outlet 180 that may be found on the cap 150 in one embodiment to retain fluid communication between the hose 124 and the internal force main 116. In one embodiment, the mechanism 182 is attached directly to the container 102.

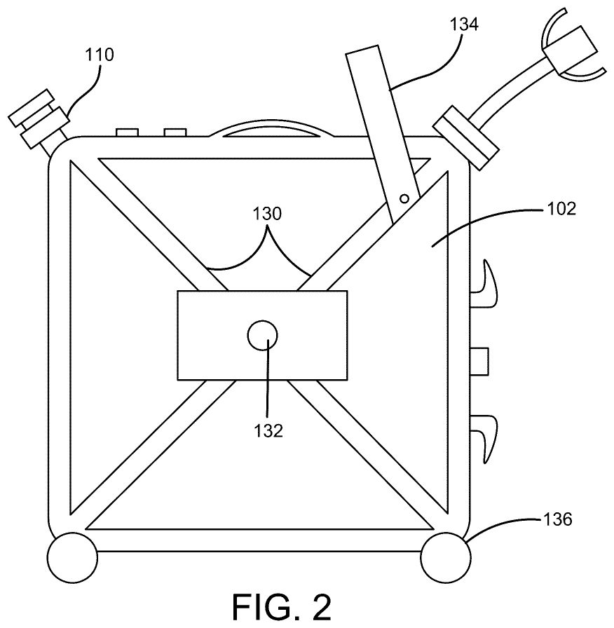

To prevent deformation during pressurization, the container 102 may be further comprised of at least one external frame support 130 in one embodiment, as seen in FIG. 2. The support 130 may be configured to interface with one or more surfaces of the container 102 and may be connected to/around the container 102 using at least one fastener 132. The fastener 132 may be a pin, bolt, or mechanical clamp that ensures structural coupling between the support 130 and container 102. The frame support 130 may be in any shape, size, and/or orientation. In one embodiment, the frame support 130 is further comprised of a handle 134 (as seen in FIG. 2), which may be a fixed or articulating handle to facilitate manual transport. The system 100 may also include a set of wheels 136 coupled to the container 102 or to the frame support 130, enabling the user to reposition or relocate the system across work areas with minimal effort.

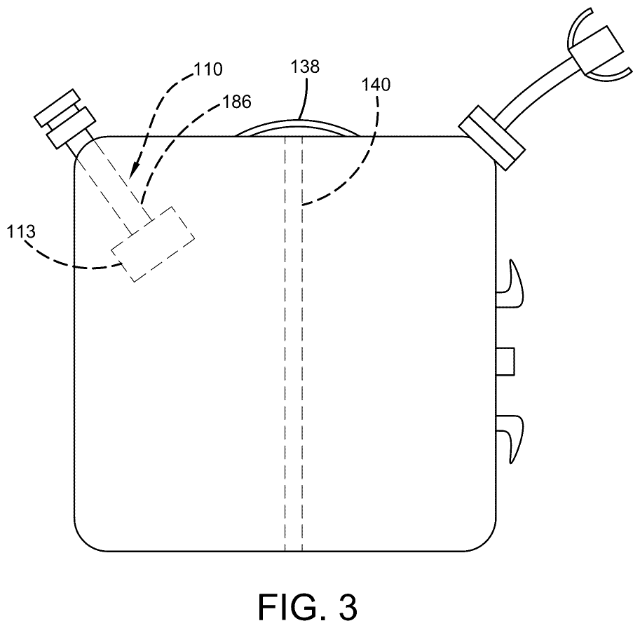

In one embodiment, the container 102 may additionally be comprised of an external lifting handle 138, which may be connected to the inner and/or outer structure of the container 102, as seen in FIG. 3. The handle 138 is secured via at least one anchoring structure 140, such as an embedded fastener, mounting boss, or structural tab integrated into the container 102. To monitor internal air pressure, the container 102 may be further comprised of a pressure gauge 142. An air release valve 144 may also be positioned on the container 102 to allowing the user to relieve internal air pressure from the container 102 as needed, either manually or automatically.

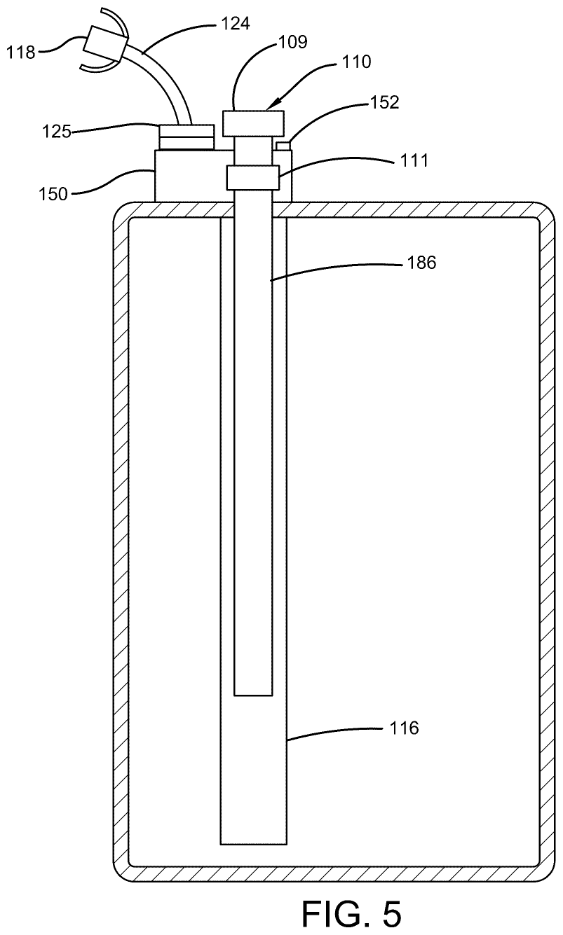

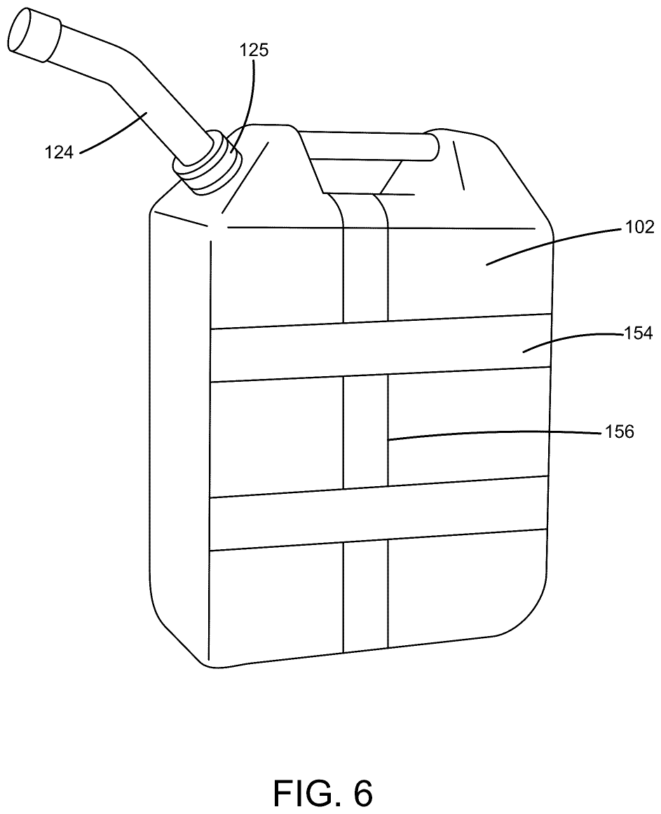

In an alternative embodiment, the system 100 is configured as a modular device designed to interface with existing gas/fuel cans or other containers, as seen in FIG. 5 and FIG. 6. In this embodiment, the system 100 is comprised of a lid 150, onto which the pump 110 is integrated. The lid 150 may be any lid style/type for any type of container. The lid 150 is configured to seal an existing container, wherein the hose 124 attaches to the lid 150 via a pair of quick-connect fasteners 125. The nozzle 118 is connected to the hose 124 and remains equipped with fastener 120 for securing to receiving vessels. The lid 150 is further comprised of an air outlet 152 for releasing pressure, as seen in FIG. 5. In other embodiments, the outlet 152 may be positioned anywhere on the device 100, such as in at least one cap 184 (which takes the place of an existing cap of the existing fuel can the system 100 is being used with), as seen in FIG. 9. The pump assembly 110 in this embodiment is equipped with at least one one-way valve 111, which may be a ball valve or other unidirectional valve, to ensure that air enters the container 102 during pumping but does not escape through the same port.

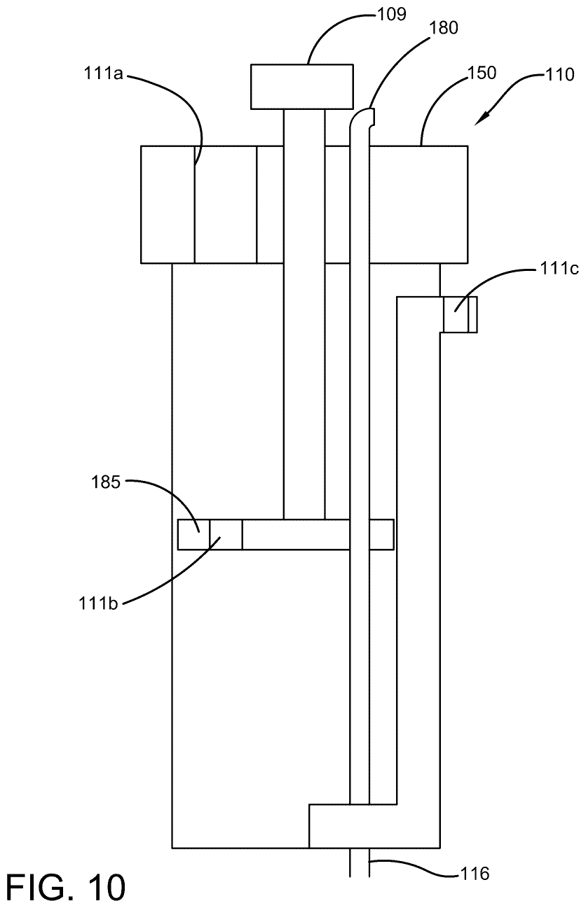

More specifically, in this embodiment a handle 109 of the pump 110 can be pushed downward such that a piston 185 (as seen in FIG. 10) forces air into the container 102. In this embodiment, air enters the assembly 110 through a first valve 111A, while a second valve 111B positioned below the piston 185 remains closed, which forces air through a third valve 111C positioned in the air tube 186, as seen in FIG. 9. The third valve 111C prevents liquid within the container 102 from backing into the air tube 186. The second valve 111B prevents air bubbles from escaping the tube 186 and collecting in the liquid after air is forced into the tube 186 by the downward motion of the handle 109 (which drives the piston 185 downward). On the upward stroke of the handle 109 and piston 185, the first valve 111A opens and the second valve 111B remains closed, thus pushing air into the container 102 which then opens the third valve 111C. The valves 111, 111A, 111B, 111C may be any type of valve or similar structure such as but not limited to ball and spring, flaps, etc.

Additionally, the force main 116 may be comprised of a telescopic configuration, allowing it to adjust in length depending on the fill level of the container 102 or the height of the container 102. In this embodiment, the portion of the pump 110 inside the container is preferably half the length of the force main 116. Further, in this (or other) embodiment(s), the pump 110 is integrated into the force main 116. This embodiment of the system 100 may also be further comprised of a plurality of side supports 154, which attach to the sides of an existing container (as seen in FIG. 6) to prevent bulging or deformation during pressurization. The side supports 154 are fastened using fasteners 156, which may include adjustable straps, locking bands, or snap-fit mechanical interfaces.

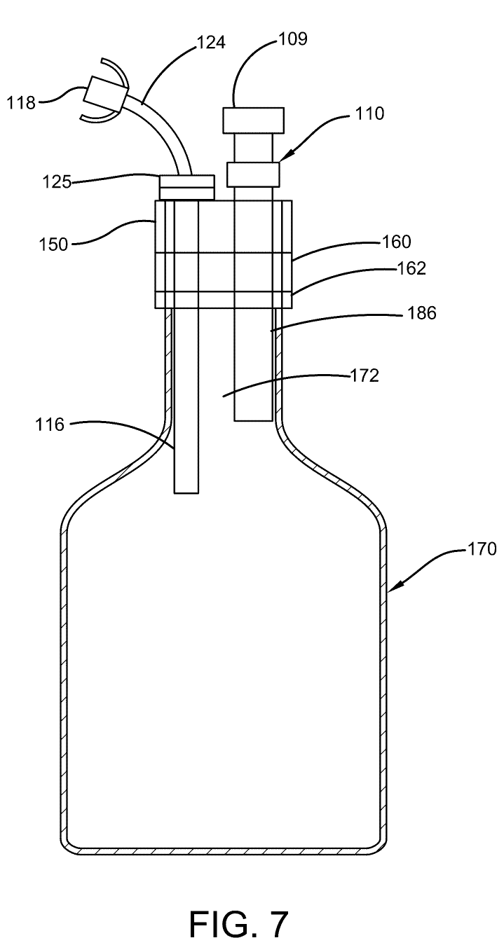

In another embodiment, the system 100 is adapted for use with water containers/jugs, as seen in FIG. 7. In this variation, the system 100 is further comprised of a flexible base 160 designed to fit around the neck 172 of a water jug 170. The base 160 is secured to/around the neck 172 using an additional fastener 162, such as but not limited to a lever ring clamp, which ensures an airtight seal during operation and maintains consistent pressurization.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “air pressure liquid transfer system” and “device” are interchangeable and refer to the air pressure liquid transfer system 100 of the present invention.

Notwithstanding the forgoing, the air pressure liquid transfer system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the air pressure liquid transfer system 100 as shown in the FIGS. are for illustrative purposes only, and that many other sizes and shapes of the air pressure liquid transfer system 100 are well within the scope of the present disclosure. Although the dimensions of the air pressure liquid transfer system 100 are important design parameters for user convenience, the air pressure liquid transfer system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An air pressure liquid transfer system comprising:
a container configured to store a liquid;
a pump fluidly connected to an interior space of the container and configured to introduce an air into the container to pressurize the liquid;
a force main connected to the container and configured to transfer the liquid from the container;
a nozzle connected to the force main, the nozzle configured to dispense the liquid from the container; and
wherein pressurization of the interior space of the container by the pump causes the liquid to be displaced through the flexible force main and out of the nozzle.

2. The air pressure liquid transfer system of claim 1, wherein the pump is comprised of a hand-actuated pump.

3. The air pressure liquid transfer system of claim 1, wherein the pump is comprised of a foot pump.

4. The air pressure liquid transfer system of claim 1, wherein the pump is comprised of an electric pump.

5. The air pressure liquid transfer system of claim 1, wherein the nozzle attaches to the container via a flexible hose.

6. The air pressure liquid transfer system of claim 1 further comprised of an expandable bladder.

7. An air pressure liquid transfer system comprising:
a container configured to store a liquid;
a pump fluidly connected to an interior space of the container and configured to introduce an air into the container to pressurize the liquid;
a force main connected to the container and configured to transfer the liquid from the container;
a nozzle connected to the force main, the nozzle configured to dispense the liquid from the container;
an external frame support; and
wherein pressurization of the interior space of the container by the pump causes the liquid to be displaced through the flexible force main and out of the nozzle.

8. The air pressure liquid transfer system of claim 7, wherein the external frame support is comprised of a handle.

9. The air pressure liquid transfer system of claim 7, wherein the external frame support is comprised of a wheel.

10. The air pressure liquid transfer system of claim 7 further comprised of a pressure gauge.

11. The air pressure liquid transfer system of claim 7, wherein the container is comprised of an air release valve.

12. An air pressure liquid transfer system comprising:
a container lid comprised of a pump;
a hose connected to the container lid via a pair of quick-connect fasteners;
a nozzle connected to the hose;
an air outlet positioned on the lid and configured to release a pressure; and
a first one-way valve.

13. The air pressure liquid transfer system of claim 12, wherein the pump is further comprised of a handle.

14. The air pressure liquid transfer system of claim 12, wherein the pump is further comprised of a piston.

15. The air pressure liquid transfer system of claim 12 further comprised of a force main.

16. The air pressure liquid transfer system of claim 15, wherein the force main is telescopic.

17. The air pressure liquid transfer system of claim 12 further comprised of a second one-way valve.

18. The air pressure liquid transfer system of claim 12 further comprised of a third one-way valve.

19. The air pressure liquid transfer system of claim 12, wherein the second one-way valve is positioned below the piston.

20. The air pressure liquid transfer system of claim 12 further comprised of an air tube.
